(19) United States
(12) Patent Application Publication
(10) Pub. No.: US 2009/0141750 A1
(43) Pub. Date: Jun. 4, 2009

(54) SYSTEMS AND METHODS FOR LINK PROCESSING WITH ULTRAFAST AND NANOSECOND LASER PULSES

(75) Inventors: Yunlong Sun, Beaverton, OR (US); Richard S. Harris, Portland, OR (US)

Correspondence Address: ELECTRO SCIENTIFIC INDUSTRIES/STOEL RIVES, LLP, 900 SW FIFTH AVE., SUITE 2600, PORTLAND, OR, 97204-1268, US

(73) Assignee: Electro Scientific Industries, Inc., Portland, OR (US)

(21) Appl. No.: 11/949,530

(22) Filed: Dec. 3, 2007

(51) Int. Cl. G21K 5/10; H01S 3/10; H01S 3/13

(52) U.S. Cl. 372/25; 372/30; 250/492.22; 257/E23.142

(57) ABSTRACT

Systems and methods for processing an electrically conductive link in an integrated circuit use a series of laser pulses having different pulse widths to remove different portions of a target structure without substantially damaging a material underlying the electrically conductive link. In one embodiment, an ultrafast laser pulse or bundle of ultrafast laser pulses removes an overlying passivation layer in a target area and a first portion of link material. Then, a nanosecond laser pulse removes a second portion of the link material to sever an electrical connection between two nodes in the integrated circuit. The nanosecond laser pulse is configured to reduce or eliminate damage to the underlying material.

### TECHNICAL FIELD

This disclosure relates to laser processing of electrically conductive links in a memory or other integrated circuit (IC). In particular, this disclosure relates to laser systems and methods using both ultrafast and nanosecond laser pulses to sever electrically conductive links and to remove passivation material over the links.

### BACKGROUND INFORMATION

Yields in IC device fabrication processes often incur defects resulting from alignment variations of subsurface layers or patterns of particulate contaminants. FIGS. 1, 2A and 2B show repetitive electronic circuits 10 of an IC device or work piece 12 that are commonly fabricated in rows or columns to include multiple iterations of redundant circuit elements 14, such as spare rows 16 and columns 18 of memory cells 20. The circuits 10 are also designed to include particular laser severable conductive links 22 between electrical contacts 24 that can be removed to disconnect a defective memory cell 20, for example, and substitute a replacement redundant cell 26 in a memory device.

The links 22 generally have a thickness between approximately 0.3 microns (μm) and approximately 2 μm, have conventional link widths 28 between approximately 0.4 μm and approximately 2.5 μm, and have link lengths 30 and element-to-element pitches (center-to-center spacings) 32 between approximately 1 μm and approximately 8 μm from adjacent circuit structures or elements 34, such as link structures 36. Although the most prevalent link materials have been poly-silicon and like compositions, other more conductive metallic link materials may be used such as aluminum, copper, gold, nickel, titanium, tungsten, platinum, as well as other metals, metal alloys, metal nitrides such as titanium or tantalum nitride, metal silicides such as tungsten silicide, or other metal-like materials.

The circuits 10, circuit elements 14, and/or cells 20 are tested for defects, the locations of which may be mapped into a database or program. Traditional 1.047 μm or 1.064 μm infrared (IR) laser wavelengths have been used to explosively remove the conductive links 22. Conventional memory link processing systems focus a single pulse of laser output having a pulse width between approximately 4 nanoseconds (ns) and approximately 30 ns at a selected link 22.

FIGS. 2A and 2B show a laser spot 38 of spot size (area or diameter) 40 impinging a link structure 36 composed of a polysilicon or metal link 22 positioned above a silicon substrate 42 and between component layers of a passivation layer stack including an overlying passivation layer 44 (shown in FIG. 2A but not in FIG. 2B), which has a typical thickness between approximately 500 angstroms (Å) and approximately 10,000 Å, and an underlying passivation layer 46. The silicon substrate 42 absorbs a relatively small proportional quantity of IR laser radiation, and conventional passivation layers 44 and 46 such as silicon dioxide or silicon nitride are relatively transparent to IR laser radiation.

FIG. 2C is a cross-sectional side view of the link structure of FIG. 2B after the link 22 is removed by a laser pulse. To avoid damage to the substrate 42 while maintaining sufficient laser energy to process a metal or nonmetal link 22, U.S. Pat. No. 5,265,114, titled “System and Method for Selectively Laser Processing a Target Structure of One or More Materials of a Multimaterial, Multilayer Device,” and U.S. Pat. No. 5,473,624, titled “Laser System and Method for Selectively Severing Links,” both by Sun et al. and assigned to Electro Scientific Industries, Inc., teach a technique of using a single laser pulse at a longer laser wavelength, such as 1.3 μm, to process the memory links 22 on silicon wafers. At the 1.3 μm wavelength, the laser energy absorption contrast between the link material and the silicon substrate 42 is much larger than that at the traditional 1 μm laser wavelengths. Link processing systems employing such methods have been used in the industry with great success by providing a much wider laser processing window (e.g., allowing a greater variation in device construction and/or laser output power and energy levels, pulse widths, and laser beam spot size to accurately process link structures) and better processing quality than that provided by other conventional link processing systems.

However, the 1 μm and 1.3 μm laser wavelengths with pulse widths in the nanosecond range have disadvantages. The energy coupling efficiency of such IR laser beams 12 into a highly electrically conductive metallic link 22 is relatively poor. Further, the practical achievable spot size 40 of an IR laser beam for link severing is relatively large and limits the critical dimensions of link width 28, and link pitch 32. As has been discussed in detail by Yunlong Sun, “Laser Processing Optimization for Semiconductor Based Devices” (unpublished doctoral thesis, Oregon Graduate Institute of Science and Technology, 1997), conventional laser link processing with nanosecond pulse width may rely on heating, melting, and evaporating the link 22, and creating a mechanical stress build-up to explosively open the overlying passivation layer 44 with a single laser pulse. Such a conventional link processing laser pulse creates a large heat affected zone (HAZ) that could deteriorate the quality of the device that includes the severed link 22. For example, when the link 22 is relatively thick or the link material is too reflective to absorb an adequate amount of the laser pulse energy, more energy per laser pulse is used to sever the link 22. Increased laser pulse energy increases the damage risk to the IC chip, including irregular or over sized opening in the overlying passivation layer, cracking in the underlying passivation layer, damage to the neighboring link structure and damage to the silicon substrate. However, using a laser pulse energy within the risk-free range on thick links often results in incomplete link severing.

U.S. Pat. No. 6,574,250, titled “Laser System and Method for Processing a Memory Link with a Burst of Laser Pulses Having Ultrashort Pulse Widths”, by Sun et al., also assigned to Electro Scientific Industries, Inc., proposed a technique of using a burst of ultrashort laser pulses for processing a link so as to reduce the heat affected zone (HAZ) and damage to other structures. Such techniques may apply a single ultrafast laser pulse or multiple ultrafast laser pulses at high repetition rates and/or in bursts. However, while the ultrafast laser pulses sufficiently remove the overlying passivation layer 44 and the link 22, the process threshold difference between the material of the link 22 and the material of the underlying passivation layer 46, based on laser intensity induced breakdown, is relatively too small to allow a wide processing window within which the ultrafast laser pulse can remove all the link material without causing any cutting into the underlying passivation layer 46.

### SUMMARY OF THE DISCLOSURE

The embodiments disclosed herein include systems and methods of using a combination of ultrafast and nanosecond laser pulses for processing electrically conductive links and an overlying passivation layer while reducing or eliminating damage to an underlying passivation layer and/or substrate.

Additional aspects and advantages will be apparent from the following detailed description of preferred embodiments, which proceeds with reference to the accompanying drawings.

### BRIEF DESCRIPTION OF THE DRAWINGS

FIG. 1 is a schematic diagram of a portion of a DRAM showing the redundant layout of and programmable links in a spare row of generic circuit cells.

FIG. 2A is a cross-sectional side view of a conventional, large semiconductor link structure receiving a laser pulse characterized by a prior art pulse parameters.

FIG. 2B is a top view of the link structure and the laser pulse of FIG. 2A, together with an adjacent circuit structure.

FIG. 2C is a cross-sectional side view of the link structure of FIG. 2B after the link is removed by the prior art laser pulse.

FIGS. 3A, 3B and 3C are cross-sectional side views of a target structure undergoing sequential stages of target processing according to one embodiment.

FIG. 4 is a flowchart illustrating a process for blowing a link according to one embodiment.

FIG. 5 is a power versus time graph illustrating an example ultrafast laser pulse and an example nanosecond laser pulse separated by a time interval according to one embodiment.

FIG. 6 is a block diagram of a system for generating an ultrafast laser pulse followed by a nanosecond laser pulse using two lasers according to one embodiment.

FIG. 7 is a block diagram of a system for generating an ultrafast laser pulse followed by a nanosecond laser pulse using a seed laser (oscillator) and an amplifier according to one embodiment.

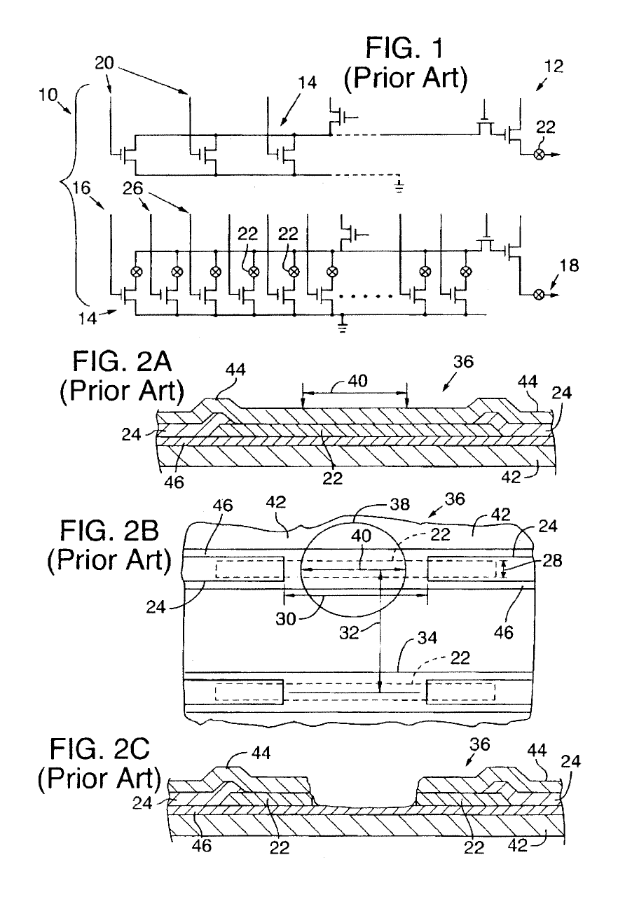

### DETAILED DESCRIPTION OF PREFERRED EMBODIMENTS

This disclosure describes the use of an ultrafast laser pulse, or a burst of ultrafast laser pulses, followed by one or more nanosecond laser pulses, with traditional temporal pulse shapes or specially tailored temporal pulse shapes, to process an electrically conductive link in an integrated circuit (IC).

The ultrafast laser pulse or pulses processes a passivation material overlying a link and a portion of the link material. In one such embodiment, the ultrafast laser pulse or pulses processes the overlying passivation layer based at least in part on laser intensity induced breakdown. In one embodiment, the ultrafast laser pulse or pulses processes a majority portion of the link.

Then, a nanosecond laser pulse completes the removal of the remaining link material. Because the processing provided by the nanosecond laser pulse is based mainly on heat generated through laser absorption by the target material and the underlying passivation material is a non-absorbing medium, the width of the nanosecond laser pulse makes the laser intensity much less than the damage threshold at which the breakdown of the underlying passivation material occurs. Thus, there is less risk of damaging (e.g., denting or cracking) the underlying passivation layer. In one embodiment, the number of the ultrafast laser pulses or nanosecond laser pulses and/or the temporal pulse shape of the nanosecond laser pulse used for processing one link may be adjusted based on the link material, a thickness of the link material, or other link structure parameters.

In the following description, numerous specific details are provided for a thorough understanding of the embodiments disclosed herein. However, those skilled in the art will recognize that the embodiments can be practiced without one or more of the specific details, or with other methods, components, or materials. Further, in some cases, well-known structures, materials, or operations are not shown or described in detail in order to avoid obscuring aspects of the embodiments.

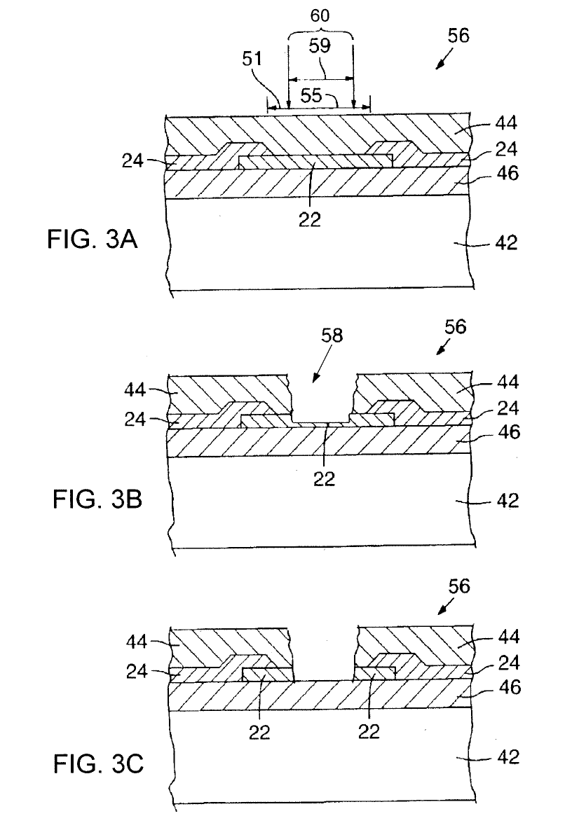

FIGS. 3A, 3B and 3C are cross-sectional side views of a target structure 56 undergoing sequential stages of target processing according to one embodiment. The target structure 56 includes an link 22, an overlying passivation layer 44 and an underlying passivation layer 46. The target structure 56 also includes a substrate 42 and electrical contacts 24.

The overlying passivation layer 44 and the underlying passivation layer 46 may include any conventionally used passivation materials such as silicon dioxide and silicon nitride, as well as fragile materials, including but not limited to, materials formed from low K dielectric materials, orthosilicate glasses (OSGs), fluorosilicate glasses, organosilicate glasses, tetraethylorthosilicate (TEOS), methyltriethoxyorthosilicate (MTEOS), propylene glycol monomethyl ether acetate (PGMEA), silicate esters, hydrogen silsesquioxane (HSQ), methyl silsesquioxane (MSQ), polyarylene ethers, benzocyclobutene (BCB), “SiLK” available from The Dow Chemical Company of Midland, Mich., or “Black Diamond” available from Applied Materials, Inc. of Santa Clara, Calif. A passivation layer 44 and/or 46 made from such a fragile material may be more prone to irregular rupture in the overlying passivation layer 44 or damage crack in the underlying passivation layer 46 when the link 22 is blown or ablated by conventional laser pulse operations.

FIG. 3A shows a target area 51 of the overlying passivation layer 44 receiving a laser spot 55 having a spot size diameter 59 of a laser output 60 characterized by an energy distribution adapted to achieve removal of the overlying passivation layer 44 and a portion of the link 22. The laser output 60 with ultra-short pulse width may have a lower energy than that of a conventional pulse of laser output because the nature of its ultra narrow pulse width, thus its higher intensity breaks down the passivation material to “drill through” the overlying passivation layer 44, rather than “blowing up” the passivation material based on a high pressure build-up, as in the case of nanosecond laser pulse width processing. A portion of the link 22 may be removed by the ultrafast laser pulse or pulses without generating significant heat in the structure 56. The lower laser energy requirement and the ultra narrow pulse width substantially increases the processing window for the parameters of the laser output 60. Thus, there is a broad range of laser sources that may be selected based on criteria such as wavelength, spot size, and availability.

As shown in FIG. 3B, one or more ultrafast laser pulses remove the overlying passivation layer 44 and a portion of the link 22 within an impinged portion 58 of the target area 51. In one embodiment, the portion of the link 22 removed by the one or more ultrafast laser pulses may include a majority of the link material without exposing the underlying passivation layer 46. Because the ultrafast laser pulses do not meet the damage threshold of the underlying passivation layer 46, they do not generate damage in the underlying passivation layer 46.

Following application of the one or more ultrafast laser pulses, one or more nanosecond laser pulses remove the remaining material of the link 22 within the impinged portion 58 of the target area 51, as shown in FIG. 3C. As discussed above, the one or more nanosecond laser pulses effectively remove the remaining link material while reducing or avoiding damage to the underlying passivation layer 46 and the substrate 42.

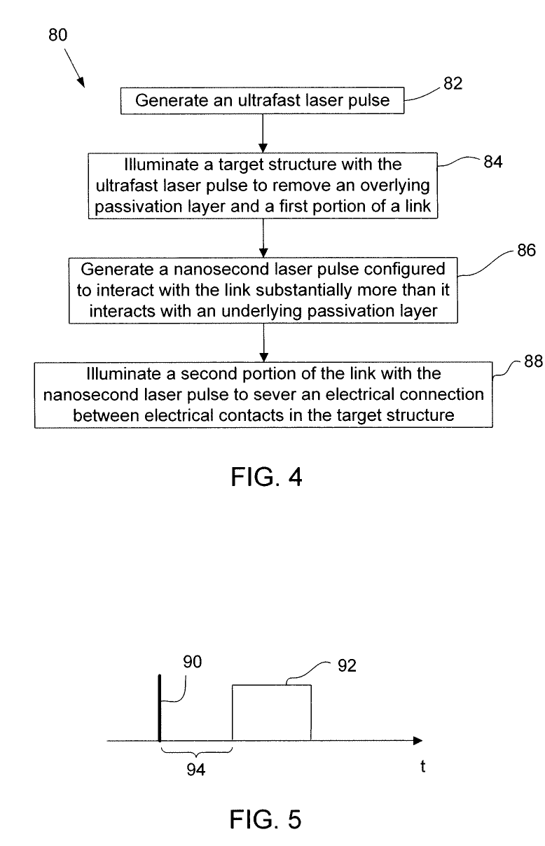

FIG. 4 is a flowchart illustrating a process 80 for blowing a link 22 according to one embodiment. With reference to FIGS. 3A, 3B, 3C and 4, the process 80 includes generating 82 an ultrafast laser pulse. In one embodiment, the ultrafast laser pulse has a pulse width that is less than approximately 1 ns. For example, in one embodiment, the ultrafast laser pulse has a pulse width in a range between approximately 100 femtoseconds (fs) and approximately 999 picoseconds (ps). In certain embodiments, the ultrafast laser pulse has a wavelength in a range between approximately 150 nanometers (nm) and approximately 2 μm. As discussed above, a plurality or burst of ultrafast laser pulses may also be generated in certain embodiments. In one such embodiment, the ultrafast laser pulses are generated at a repetition rate greater than approximately 10 MHz.

The process 80 also includes illuminating 84 the target structure 56 with the ultrafast laser pulse to remove the overlying passivation layer 44 in the target area 51 and a first portion of the link 22. As shown in FIG. 3B, the ultrafast laser pulse does not remove all of the link 22 such that the underlying passivation layer 46 is not exposed (e.g., a second portion of the link 22 continues to substantially cover the underlying passivation layer 46). In certain embodiments, the ultrafast laser pulse reduces the thickness of the link 22 in the target area 51 by at least half. In other embodiments, the ultrafast laser pulse reduces the thickness of the link 22 between approximately 50% and approximately 95%.

The process 80 further includes generating 86 a nanosecond laser pulse configured to sever the remaining link 22 with substantially no damage to the underlying passivation layer 46 and substrate 42.

In one embodiment, the nanosecond laser pulse has a traditional temporal shape with a pulse width in a range between approximately 1 ns and approximately 50 ns. In certain embodiments, the nanosecond laser pulse has a wavelength in a range between approximately 150 nm and approximately 2 μm. As discussed above, a plurality of nanosecond laser pulses and/or nanosecond laser pulses with specially tailored temporal pulse shapes may also be generated in certain embodiments.

The process 80 further includes illuminating 88 the second portion of the link 22 with the nanosecond laser pulse to sever the electrical connection between the electrical contacts 24 in the target structure 56. Because the much lower intensity of the nanosecond laser pulse, the underlying passivation layer 46 is substantially damage free as compared to if the ultrafast laser pulses were used to server the link 22 such that the underlying passivation layer 46 is directly exposed to the main central part of the laser spot. When a UV laser wavelength of shorter than approximately 400 nm is used for the nanosecond laser pulse, the underlying passivation material becomes slightly absorbing in this wavelength range. However, due to the fact that much less laser energy is needed to serve the remaining portion of the link 22, the damage risk to the underlying passivation 46 is greatly reduced.

FIG. 5 is a power versus time graph illustrating an example ultrafast laser pulse 90 and an example nanosecond laser pulse 92 separated by a time interval 94 according to one embodiment. The sequential laser pulses 90, 92 may be used as the laser output 60 shown in FIG. 3A to sever a link 22 without damaging an underlying passivation layer 46, as discussed herein. Although not shown in FIG. 5, one or more ultrafast laser pulses 90 may be followed by one or more nanosecond laser pulses 92, depending on the properties of the particular materials and the thickness of the materials.

The time interval 94 between the laser pulses 90, 92 according to one embodiment may be less than approximately 100 ns. For example, in one embodiment, there may be no delay between the laser pulses 90, 92 such that the time interval 94 is approximately zero. In another embodiment, the time interval 94 between pulses may be in a range between approximately zero and approximately 500 ns. As discussed below, the time interval 94 in certain embodiments may be user-selectable or programmable. The selected time interval 94 may be based at least in part on a speed of a laser positioning system, and/or link structure parameters such as link thickness, link pitch size and link material.

The ultrafast laser pulse 90 has insufficient energy to fully sever the link 22 or damage the underlying passivation layer 46. Rather, the ultrafast laser pulse 90 is configured to remove the overlying passivation layer 44 and a first portion of the link 22. The nanosecond laser pulse 92 is configured to remove a second portion of the link 22 so as to sever the electrical connection between the electrical contacts 24 without damaging the underlying passivation layer 46 or the substrate 42.

Depending on the respective wavelengths and the characteristics of the link material, the severing depth of the laser pulses 90, 92 applied to the target structure 56 may be accurately controlled by choosing the energy of each laser pulse 90, 92 and the number of ultrafast laser pulses 90 and/or nanosecond laser pulses 92. Hence, the risk of damage to the underlying passivation layer 46 and/or the silicon substrate 42 is reduced or substantially eliminated, even if an ultrafast and/or nanosecond laser wavelength in the UV range is used.

In one embodiment, the ultrafast laser pulse 90 and the nanosecond laser pulse 92 may have mutually different wavelengths. For example, the ultrafast laser pulse 90 may have a wavelength of approximately 1.064 μm or its harmonics of green or UV, and the nanosecond laser pulse 92 may have a wavelength of approximately 1.3 μm. In another embodiment, the ultrafast laser pulse 90 and the nanosecond laser pulse 92 may have the same wavelength. In one embodiment, either of the laser pulses 90, 92 may have a laser pulse energy in a range between approximately zero Joules (J) and approximately 10 μJ, with the other laser pulse 90, 92 having a laser pulse energy in a range between approximately 0.001 μJ and approximately 10 μJ.

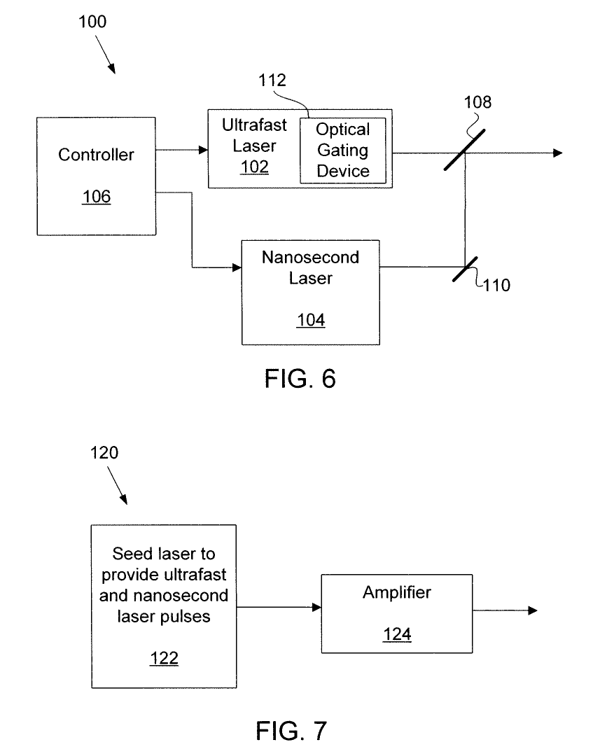

FIG. 6 is a block diagram of a system 100 for generating a laser output (such as the laser output of 60 shown in FIG. 3A) that includes an ultrafast laser pulse 90 followed by a nanosecond laser pulse 92 using two lasers according to one embodiment. The system 100 includes an ultrafast laser 102, a nanosecond laser 104, and a controller 106. The ultrafast laser 102 generates the ultrafast laser pulse 90 and provides the ultrafast laser pulse 90 to the target area 51 through a first optical path that includes a combiner 108. The nanosecond laser 104 generates the nanosecond laser pulse 92 and provides the nanosecond laser pulse 92 to the target area 51 through a second optical path that includes a mirror 110 and the combiner 108.

In one embodiment, the ultrafast laser 102 includes an optical gating device 112 configured to gate out at least one or a bundle of ultrafast laser pulses at a predetermined repetition rate. The optical gating device 112 may include, for example, an electro-optic device. In one embodiment, firing of the nanosecond laser 102 is synchronized with the optical gating device 112 of the ultrafast laser 102 so as to sequentially provide the laser pulses 90, 92 to the target area 51 and to selectively control the time interval 94 between the laser pulses 90, 92.

The controller 106 is configured to execute instructions for performing processes as disclosed herein. In one embodiment, the controller 106 is programmable so as to select, and/or so as to allow a user to select, the time interval 94 between the laser pulses 90, 92. The controller 106 may directly trigger the gating of the ultrafast laser 102 and firing of the nanosecond laser 104 so as to synchronize the laser pulses 90, 92, as discussed herein. In addition, or in another embodiment, the controller 106 may selectively fire the nanosecond laser 104 based on a signal from the optical gating device 112 to provide a predetermined or user-selected delay between the ultrafast laser pulse 90 and the nanosecond laser pulse 92.

The controller 106 may also be configured to control the ultrafast laser 102 and/or the nanosecond laser 104 so as to provide laser pulse energies, laser pulse widths, multiple laser pulses (e.g., a burst of pulses) produced by each laser 102, 104, and/or pulse shapes based at least in part on the characteristics of the target structure 56.

The controller 106 may use the position data to direct the focused laser spot 38 over the work piece 12 to the target link structure 36 with at least one each of the ultrafast laser pulse 90 and the nanosecond laser pulse 92 to remove the link 22. The system 100 may sever each link 22 on-the-fly without stopping the motion platform or stage, so high throughput is maintained. Because the laser pulses 90, 92 are temporally separated in one embodiment by approximately 100 ns or less, the controller 106 treats the set of pulses 90, 92 as a single pulse when controlling the motion platform or stage.

An example ultrafast laser 102 includes a mode-locked Ti-Sapphire ultrafast pulse laser with a laser wavelength in the near IR range, such as between approximately 750 nm and approximately 850 nm. For example, Spectra Physics makes a Ti-Sapphire ultra fast laser called the MAI TAI™ that provides ultrafast pulses 90 having a pulse width of approximately 150 fs at approximately 1 Watt (W) of power in the 750 nm to 850 nm range at a repetition rate of approximately 80 MHz.

An example nanosecond laser 104 includes a diode pumped, AO Q-switched laser such as M112 supplied by JDSU Corporation of Milpitas, California. This laser delivers laser pulse of widths from 5 ns to 30 ns at a repetition rate of up to approximately 100 KHz with wavelengths of 1.064 or 1.3 micron. Fiber laser supplied by INO of Canada is another example of nanosecond pulse laser with a tailored temporal pulse shape.

FIG. 7 is a block diagram of a system 120 for generating an ultrafast laser pulse 90 followed by a nanosecond laser pulse 92 using a seed laser 122 (oscillator) and an amplifier 124 according to one embodiment. The seed laser 122 may be a combination of two separate lasers (not shown). The first laser includes an ultrafast seeding laser followed by a gating device (e.g., an electro-optic or other device) to select a single ultrafast laser pulse 90 or a set of ultrafast laser pulses 90 to deliver to the target structure 56. The second laser includes a nanosecond seeding laser synchronized with the gating device of the ultrafast laser to produce one or more nanosecond laser pulses 92 delayed by a desired time interval 94 with respect to the one or more ultrafast laser pulses 90. The amplifier 124 is configured to amplify both the ultrafast laser pulse 90 and the nanosecond laser pulse 92 to provide sufficient energy to remove their respective target materials.

It will be obvious to those having skill in the art that many changes may be made to the details of the above-described embodiments without departing from the underlying principles of the invention. The scope of the present invention should, therefore, be determined only by the following claims.

1. A method for selectively removing material from a target location of a selected link structure, the link structure comprising an electrically conductive link to provide an electrical connection between a pair of electrical contacts, the electrically conductive link located between an overlying passivation layer and an underlying passivation layer on a semiconductor substrate, the method comprising:
generating a first laser pulse within a first predetermined range of pulse widths;
illuminating the link structure with the first laser pulse to remove the overlying passivation layer at the target location and a first portion of the electrically conductive link at the target location, wherein removing the first portion of the conductive link exposes an underlying second portion of the electrically conductive link;
generating a second laser pulse within a second predetermined range of pulse widths, the second predetermined range being outside the first predetermined range, the second predetermined range of pulse widths being selected such that an energy delivered by the second laser pulse is less than a damage threshold of the underlying passivation layer and the semiconductor substrate; and
illuminating the second portion of the electrically conductive link with the second laser pulse to sever the electrical connection between the pair of electrical contacts without substantially causing damage to the underlying passivation layer and the semiconductor wafer.

2. The method of claim 1, wherein the first predetermined range of pulse widths is less than approximately 1 nanosecond.

3. The method of claim 2, wherein the second predetermined range of pulse widths is between approximately 1 nanosecond and approximately 50 nanoseconds.

4. The method of claim 1, wherein the first predetermined range of pulse widths is less than approximately 10 nanoseconds.

5. The method of claim 1, further comprising delaying delivery of the second laser pulse with respect to delivery of the first laser pulse to the target location by a delay time in a range between approximately zero seconds and approximately 500 nanoseconds.

6. The method of claim 1, wherein the first portion of the electrically conductive link comprises at least as much electrically conductive material as that of the second portion of the electrically conductive link.

7. The method of claim 1, further comprising:
generating one or more third laser pulses within the first predetermined range of pulse widths; and
sequentially illuminating the link structure with the first laser pulse and the one or more third laser pulses to remove the overlying passivation layer at the target location and the first portion of the electrically conductive link at the target location.

8. The method of claim 7, further comprising generating the first laser pulse and the one or more third laser pulses at a repetition rate of greater than approximately 10 MHz.

9. The method of claim 7, wherein the first laser pulse and the one or more third laser pulses comprise the same pulse energy as one another.

10. The method of claim 7, wherein the first laser pulse and the one or more third laser pulses comprises different pulse energies than one another.

11. The method of claim 1, further comprising:
generating one or more third laser pulses within the second predetermined range of pulse widths; and
sequentially illuminating the second portion of the electrically conductive link with the second laser pulse and the one or more third laser pulses to sever the electrical connection between the pair of electrical contacts.

12. The method of claim 11, wherein the second laser pulse and the one or more third laser pulses comprise the same pulse energy as one another.

13. The method of claim 11, wherein the second laser pulse and the one or more third laser pulses comprises different pulse energies than one another.

14. The method of claim 11, further comprising shaping at least one of the second laser pulse and the one or more third laser pulses.

15. The method of claim 1, wherein the first laser pulse and the second laser pulse comprise the same wavelength.

16. The method of claim 1, wherein the first laser pulse and the second laser pulse comprise different wavelengths.

17. The method of claim 1, wherein at least one of the first laser pulse and the second laser pulse has a wavelength in a range between approximately 150 nanometers and approximately 2 microns.

18. The method of claim 1, wherein at least one of the first laser pulse and the second laser pulse has a laser pulse energy in a range between approximately 0.001 microJoules and approximately 10 microJoules.

19. A laser system for removing material from a target location of a selected link structure, the link structure comprising an electrically conductive link to provide an electrical connection between a pair of electrical contacts, the electrically conductive link located between an overlying passivation layer and an underlying passivation layer, the system comprising:
a first laser source for generating a first laser pulse; and
a second laser source synchronized with the first laser source to generate a second laser pulse at a predetermined time after the generation of the first laser pulse,
wherein the first laser pulse is within a predetermined range of pulse widths and the second laser pulse is outside of the predetermined range of pulse widths.

20. The laser system of claim 19, wherein the predetermined range of pulse widths is less than approximately 1 nanosecond, and wherein the second laser pulse has a pulse width between approximately 1 nanosecond and approximately 50 nanoseconds.

21. The laser system of claim 19, wherein at least one of the first laser pulse and the second laser pulse has a wavelength in a range between approximately 150 nanometers and approximately 2 microns.

22. The laser system of claim 19, wherein the first laser pulse is configured to remove the overlying passivation layer at the target location and a portion of the electrically conductive link, and wherein the second laser pulse is configured to sever the electrical connection between the pair of electrical contacts without substantially causing damage to the underlying passivation layer.

23. The laser system of claim 19, further comprising a controller configured to allow a user to selectively adjust the predetermined time between the generation of the first laser pulse and the generation of the second laser pulse.

24. A system for processing an electrically conductive link, the system comprising:
means for generating a first laser pulse in a first range of pulse widths;
means for generating a second laser pulse in a second range of pulse widths;
means for selectively illuminating a target location of an integrated circuit with the first laser pulse to remove a first portion of the electrically conductive link; and
means for illuminating the target location with the second laser pulse to remove a second portion of the electrically conductive link thereby severing the electrically conductive link without substantially damaging a material underlying the electrically conductive link.
